(19) United States
(12) Patent Application Publication
(10) Pub. No.: US 2019/0138251 A1
(43) Pub. Date: May 9, 2019

(54) IMAGE PROCESSING APPARATUS

(71) Applicant: SHARP KABUSHIKI KAISHA, Sakai City (JP)

(72) Inventor: Yohsuke KONISHI, Sakai City (JP)

(21) Appl. No.: 16/183,581

(22) Filed: Nov. 7, 2018

(30) Foreign Application Priority Data
Nov. 8, 2017 (JP) 2017-215396

(51) Int. Cl. G06F 3/12; H04N 1/32

(52) U.S. Cl. CPC G06F 3/1204; H04N 1/32149; G06F 3/1288; G06F 3/1231

(57) ABSTRACT

There is provided an image processing apparatus including a setting information acquisition unit acquiring setting information corresponding to an inputted predetermined setting item, an embedment information generation unit converting the acquired setting information into embedment setting information having a predetermined data structure, an image input unit inputting information written on a document as image data based on the setting information, an image setting synthesis unit generating synthesized information obtained by synthesizing the inputted image data and the embedment setting information, and an output unit outputting the synthesized information, in which the embedment setting information is placed in an area not outputted in the synthesized information.

### BACKGROUND

### 1. Field

The present disclosure relates to an image processing apparatus and, more particularly, to an image processing apparatus capable of processing image data including setting information such as a print setting set by a user.

### 2. Description of the Related Art

In the related art, image forming apparatuses are used. In recent years, multifunction peripheral apparatuses which have various functions such as a document scanning function, a network connecting function, in addition to a document copying function, have been used.

For example, when a user intends a multifunction peripheral apparatus to print a document, the user causes the multifunction peripheral apparatus to execute a document printing after performing a predetermined selection input for setting items such as the number of copies to be printed, selection of a printing paper sheet, setting of magnification or reduction ratio, setting of single-sided or double-sided printing, or selection of a type of document to be scanned.

There is also a multifunction peripheral apparatus having a function of scanning information written on a paper sheet and converting the information into a document of a predetermined format such as a PDF format and saving the document. When a user intends to use the function, the user causes the multifunction peripheral apparatus to execute scanning of a paper sheet after performing a predetermined selection input for setting items such as designation of a conversion format, designation of a resolution or a color, and setting of single-sided or double-sided scanning.

Generally, when inputting such setting items, the user may input the setting items each time by using a keyboard or a touch panel. If the number of items is large, an operation is cumbersome, and if the user is not familiar with the operation, it takes time.

Therefore, a user-specific print setting information, in which several setting items frequently used are grouped, is stored in the multifunction peripheral apparatus in advance, and when it is desired to print or the like with a same setting next time, the stored user-specific print setting information is read out and the printing is executed.

Japanese Unexamined Patent Application Publication No. 2006-80940 proposes an image data processing apparatus in which, a user inputs an instruction for processing a document or image data to be processed, the inputted series of instructions are converted into a two-dimensional code information, thereafter, the two-dimensional code information is printed on a paper medium, and next time when the user wants the image data processing apparatus to perform the same process on another document or the like, it is possible to perform the desired process by scanning the printed two-dimensional code information instead of the user inputting the instruction again.

Japanese Unexamined Patent Application Publication No. 2006-4183 proposes an image processing apparatus in which, by using an annotation function of a PDF file capable of embedding additional writing information, the user writes print setting information in the annotation of the PDF file to be printed and the created PDF file including the annotation is transmitted. On the other hand, when the PDF file to be printed is received and the annotation of the received PDF file includes the print setting information, the print setting information is extracted from the annotation. Subsequently, printing conditions according to the print setting information is set, and then a printing process of the PDF file is performed based on the printing conditions.

In the related art, in a case where user-specific scan setting information is stored in advance, and scanning is executed by reusing the user-specific scan setting information, the scan process may be performed efficiently if the number of users who use the image forming apparatus is limited or the number of scan setting information is small.

However, when there are an unspecified number of users using the image forming apparatus or when a large number of user-specific scan setting information is stored, it takes time for the user to select the user-specific scan setting information to be used for scanning due to the large number of scan setting information stored in advance or it may not be possible to determine which scan setting information the user wants to use at present, which imposes a heavy operation burden on the user.

According to Japanese Unexamined Patent Application Publication No. 2006-80940, when the two-dimensional code information obtained by converting the series of instructions inputted by the user is printed on the paper medium and reused for the next scan, the user may strictly manage the paper medium so that the paper medium on which the two-dimensional code information is printed is not lost, and not to be torn. If the paper medium is lost or damaged, the user may input the same scan setting information again and output a paper medium on which the two-dimensional code information is printed, which imposes a heavy management and operation burden on the user.

According to Japanese Unexamined Patent Application Publication No. 2006-4183, when the user writes the print setting information in the annotation of the PDF file to be printed and causes the print setting information to be stored in the PDF file, the PDF file can be printed using any printing apparatus at any time by using the print setting information written in the PDF file.

The printing of the PDF file in which the print setting information is written is not accompanied by cumbersome setting input by the user. However, since it is performed based only on the print setting information written in the PDF file, the printing is not able to be executed based on the print setting information written in another PDF file. When it is desired to change only a part of the setting items of the print setting information written in the PDF file, the user may perform an operation input to reset the print setting items.

Furthermore, when a separate PDF file is additionally created, if it is attempted to embed print setting information having the same content as the previously created PDF file in the separate PDF file, in each case, the user may perform an operation input to write the print setting information in the annotation of the separate PDF file, which imposes a heavy operation burden on the user.

### SUMMARY

It is desirable to provide an image processing apparatus with which a user may not need to manage a paper medium on which two-dimensional code information corresponding to setting information such as scanning is printed, with which a user can easily set setting information of new image information to be outputted by scanning or the like by using setting information such as scanning stored corresponding to image information already converted into electronic data, and which is capable of reducing an operation burden on the user when inputting the setting items for causing the image processing apparatus to execute a predetermined function.

According to an aspect of the disclosure, there is provided an image processing apparatus, including, a setting information acquisition unit acquiring setting information corresponding to an inputted predetermined setting item, an embedment information generation unit converting the acquired setting information into embedment setting information having a predetermined data structure, an image input unit inputting information written on a document as image data based on the setting information, an image setting synthesis unit generating synthesized information obtained by synthesizing the inputted image data and the embedment setting information, and an output unit outputting the synthesized information, wherein the embedment setting information is placed in an area not outputted in the synthesized information.

According to another aspect of the disclosure, there is provided an image processing method of an image processing apparatus, including, acquiring setting information corresponding to an inputted predetermined setting item, converting the acquired setting information into embedment setting information having a predetermined data structure, inputting information written on a document as image data, based on the setting information, generating synthesized information obtained by synthesizing the inputted image data and the embedment setting information, and outputting the synthesized information, wherein the embedment setting information is placed in an area not outputted in the synthesized information.

### BRIEF DESCRIPTION OF THE DRAWINGS

FIG. 1 is a configuration block diagram of an image processing apparatus according to an embodiment of the present disclosure;

FIGS. 2A and 2B are explanatory diagrams of information stored in the image processing apparatus according to the embodiment of the present disclosure;

FIG. 3 is an explanatory diagram of information stored in the image processing apparatus according to the embodiment of the present disclosure;

FIG. 4 is a flowchart of an acquisition process of PDF setting information on the image processing apparatus according to the embodiment of the present disclosure;

FIG. 5 is a flowchart of an acquisition process of PDF setting information from a two-dimensional code according to the embodiment of the present disclosure;

FIG. 6 is a flowchart of a generation process of PDF synthesized information on the image processing apparatus according to the embodiment of the present disclosure;

FIG. 7 is a flowchart of a generation process of synthesized information using PDF embedment setting information on the image processing apparatus according to the embodiment of the present disclosure;

FIG. 8 is a flowchart of a generation process of two-dimensional code using the PDF embedment setting information on the image processing apparatus according to the embodiment of the present disclosure; and

FIG. 9 is a flowchart of a generation process of synthesized information using the two-dimensional code on the image processing apparatus according to the embodiment of the present disclosure.

### DESCRIPTION OF THE EMBODIMENTS

Hereinafter, embodiments according to the present disclosure will be described below with reference to the drawings. Note that the present disclosure is not limited by the description of the following embodiments.

### Configuration of Image Processing Apparatus

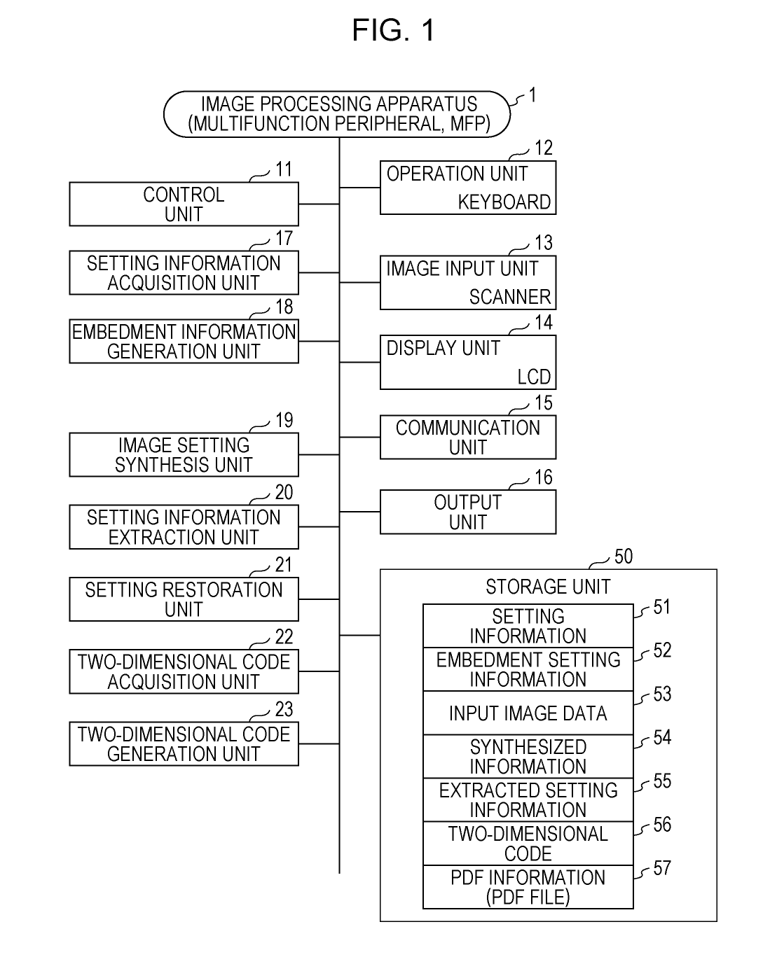

FIG. 1 is a configuration block diagram of an image processing apparatus according to the embodiment of the present disclosure.

An image processing apparatus (hereinafter, also referred to as multifunction peripheral: MFP) 1 is an apparatus that processes image data, and the image processing apparatus 1 is an electronic apparatus including, for example, a copying function, a printing function, a document scanning function (scanning function), an image setting synthesis function, a facsimile function, a communication function, and the like.

In particular, according to the present disclosure, the image processing apparatus includes the image setting synthesis function that generates image information (image file) in a predetermined format by synthesizing image data scanned by using the document scanning function and setting item information set a time of the scanning.

In order to execute the document scanning function, the image processing apparatus includes a document table on which a document to be scanned is placed. The document on which characters, images or the like are written is placed on the document table so that the document can be fit in a scanning area of the document table, and information written on the document is scanned as an input image by a user performing a predetermined scanning start operation after the user performs a setting input of setting items which may need for scanning. The input image data and information corresponding to the setting items in which the setting input is performed, are synthesized and stored as image information in one predetermined format.

In FIG. 1, the image processing apparatus (MFP) 1 of the present disclosure mainly includes a control unit 11, an operation unit 12, an image input unit 13, a display unit 14, a communication unit 15, an output unit 16, a setting information acquisition unit 17, an embedment information generation unit 18, an image setting synthesis unit 19, a setting information extraction unit 20, a setting restoration unit 21, a two-dimensional code acquisition unit 22, a two-dimensional code generation unit 23, and a storage unit 50.

The control unit 11 is a part for controlling an operation of each constituent element such as the image input unit 13, and is mainly realized by a microcomputer including a CPU, a ROM, a RAM, an I/O controller, a timer, and the like.

The CPU operates various types of hardware organically based on a control program stored in advance in a ROM or the like to execute a setting information acquisition function, an image setting synthesis function, or the like according to the present disclosure. In particular, the setting information acquisition unit 17, the embedment information generation unit 18, the image setting synthesis unit 19, the setting information extraction unit 20, the setting restoration unit 21, the two-dimensional code acquisition unit 22, and the two-dimensional code generation unit 23 are functional blocks that a CPU executes in terms of software based on a predetermined program.

The operation unit 12 is a part for inputting the setting items, or the like, which may need for inputting information such as characters, performing a selection input of functions, executing functions, and, for example, a keyboard, a mouse, a touch panel, or the like are used. In the disclosure, in order to generate the image information (image file) in a predetermined format, a user uses the operation unit 12 and inputs a content of the desired setting items.

The image input unit 13 is a part for inputting information written on a document which is a source of image information as image data based on the setting information obtained by a user performing the setting input. For example, the image input unit 13 inputs information such as a document in which images, characters, figures, or the like, are written. The inputted information is stored in the storage unit 50 as electronic data in a predetermined image format. The image input unit 13 scans a document placed on the document table mainly using a scanner (scanning device) for scanning the document in which information is written.

There are various methods for inputting the image information, and an exemplary method is that the document in which the information is written is scanned by the scanner and the electronic data obtained by digitizing the content of the document is stored in the storage unit 50 as input image data.

However, the methods of inputting information such as an image are not limited to the above, and an interface for connecting an external storage medium such as a USB memory corresponds to the image input unit 13, for example. An electronic data file such as an image or a document to be inputted is saved in the external storage medium such as a USB memory. The USB memory or the like is connected to an input interface such as a USB terminal, and a predetermined input operation is performed in the operation unit 12, and a desired electronic data file saved in the USB memory or the like may be read out and stored in the storage unit 50 as electronic data.

In a mobile terminal, a user may select a desired electronic data file, the selected electronic data file may be transferred to the image processing apparatus MFP, and the electronic data file received via the communication unit 15 may be stored in the storage unit 50 as electronic data.

The image information inputted by the scanner or the like is saved as electronic data in a predetermined image format in the storage unit 50. As a file format for storing the electronic data, any existing file formats currently in use can be used. Existing file formats are, for example, a PDF format, a TIFF format, a JPEG format, or the like. If there are many file formats that can be used, a user may perform a selection input of a desired file format for saving the image information before starting scanning of a document.

A file structure of each image format is predefined for each specific format, and, in general, the file structure includes a so-called header area that stipulates a structure of data or a compression method, and an image area including image data itself. For example, a PDF format includes image data, drawing commands corresponding to the image data, and a non-drawing command area starting from a head of a PDF file. The drawing commands are commands for instructing a computer on display conditions or the like, when an image corresponding to an image file is displayed on a display screen of the computer. The non-drawing command area is an area where an output such as a display is not performed. In a PDF format, the non-drawing command area stores an identifier (PDF identification information) for distinguishing that the image information is in a PDF format, information that a user specifically defines, or the like. In a TIFF format file structure, user-specific information can be embedded by defining an extension tag in a header area. In a JPEG format file structure, user-specific information can be embedded in a segment stipulated by a COM marker that embeds text data.

In the following embodiment, description will be made assuming that a PDF format is used as a format for saving image information. Further, the setting items in which a user has performed a setting input are stored as PDF embedment setting information in a predetermined description format as described later in an area which does not affect a display in a PDF format file structure, for example, in the non-drawing command area. Note that, the file structure such as the above-described TIFF format, JPEG format, or the like, can also embed the setting items in which a user has performed a setting input, into each image data file as user-specific information, and the image information handled in the present disclosure is not limited to a PDF format.

The display unit 14 is a part for displaying information, and the display unit 14 displays information useful for executing each function, a result of execution of the function, or the like, in order to notify the user. When embedment setting information is placed in an area not outputted in synthesized information, the display unit 14 may display the embedment setting information in a readable state. As the display unit 14, for example, an LCD, an organic EL display, or the like is used, and, when a touch panel is used as the operation unit 12, the display unit and the touch panel are disposed in an overlapped manner.

The communication unit 15 is a part for performing data communication with another communication apparatus via a network. For example, as described above, the communication unit 15 receives an electronic data file transferred from a mobile terminal or a server. In addition, the image information obtained by synthesizing the input image data generated by the image processing apparatus MFP of the present disclosure and the setting items in which the setting input is performed, is transmitted to the mobile terminal or the server. As the network, any existing communication networks such as a wide area communication network such as the Internet, LAN, or the like can be used and either a wired communication or a wireless communication may be used.

The output unit 16 is a part for outputting the generated image information. In the present disclosure, the synthesized information which is image information obtained by synthesizing the input image data and the setting items, is outputted. In particular, the output unit 16 outputs the synthesized information by at least one process of display of the synthesized information and transmission of the synthesized information, to another information processing apparatus.

The output unit 16 corresponds to, for example, a printer that prints image information on a paper medium and outputs the paper medium. When printing the image information (synthesized information) obtained by synthesizing the input image data and the setting items, in principle, the output unit 16 prints only the information of the part corresponding to the input image data on the paper medium. Alternatively, contents of the setting items may be printed in a format such that a user can visually review the contents. For example, the contents of the setting items may be printed with characters or symbols, or may be printed with two-dimensional codes or barcodes.

Output of information is not limited to the printing as described above, and the output of information may be to store information on an external storage medium such as a USB memory, to display information on the display unit 14, or to transmit such information to another information processing apparatus or server via a network such as the Internet.

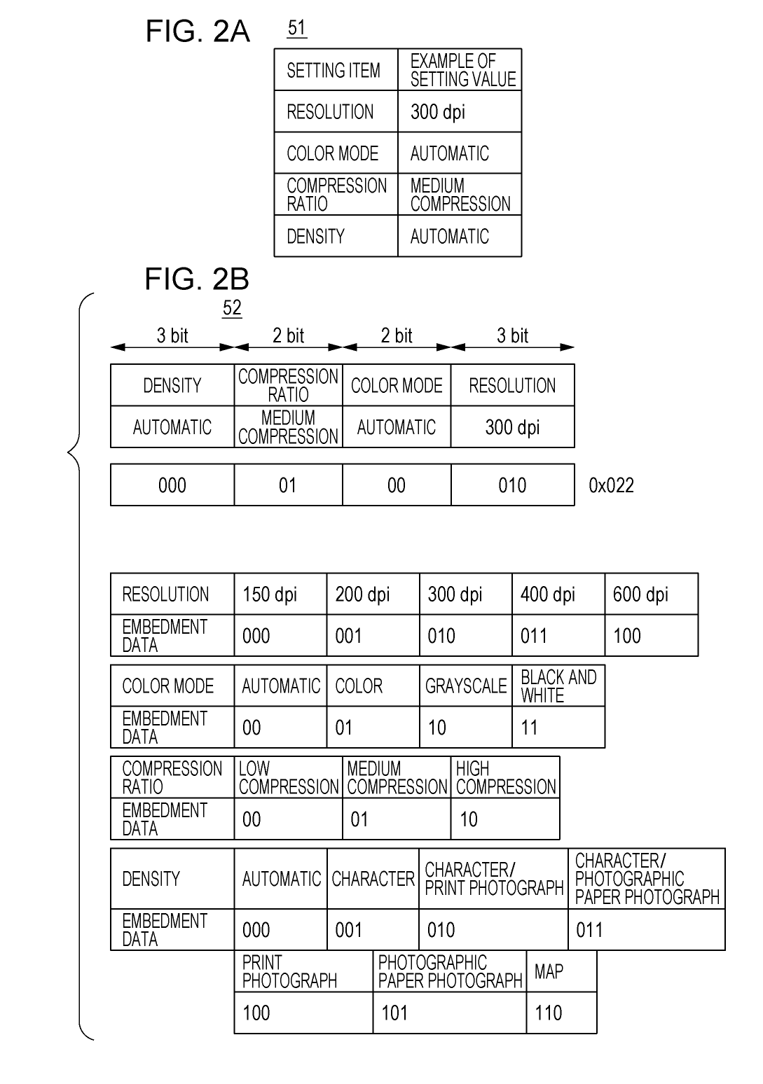

The setting information acquisition unit 17 is a part for acquiring setting information corresponding to predetermined setting items inputted by a user. For example, when image information of a predetermined format such as a PDF format is generated from input image data, the setting information acquisition unit 17 acquires information (hereinafter, referred to as setting information) of setting items in which a setting input is performed by a user in advance. When a document is scanned using the scanner, the user may perform the setting input in advance of the setting items such as a resolution, a color, a compression, a density, or the like, or contents of setting items stored in the storage unit in advance are read out. The setting items in which the setting input is performed, or the contents of the setting items read out, are acquired as setting information. The acquired setting information is converted into embedment setting information and included in one piece of synthesized information as described later. The setting information of the embodiment is shown in FIGS. 2A and 2B to be described later.

The embedment information generation unit 18 is a part for converting acquired setting information into embedment setting information having a predetermined data structure. The embedment setting information is, when image information is generated in a predetermined file format, information obtained by converting acquired setting information into information that can be embedded in image information. For example, in a case of generating file information (referred to as PDF information or PDF file) in a PDF format, as described later, the acquired setting information is converted into the embedment setting information which can be included in a non-drawing command area of PDF information. After the conversion, the PDF embedment setting information is included in the non-drawing command area together with predetermined embedment identification information. The setting information of the embodiment is shown in FIGS. 2A and 2B to be described later. Note that, if possible, the acquired setting information may be used as the embedment setting information as it is.

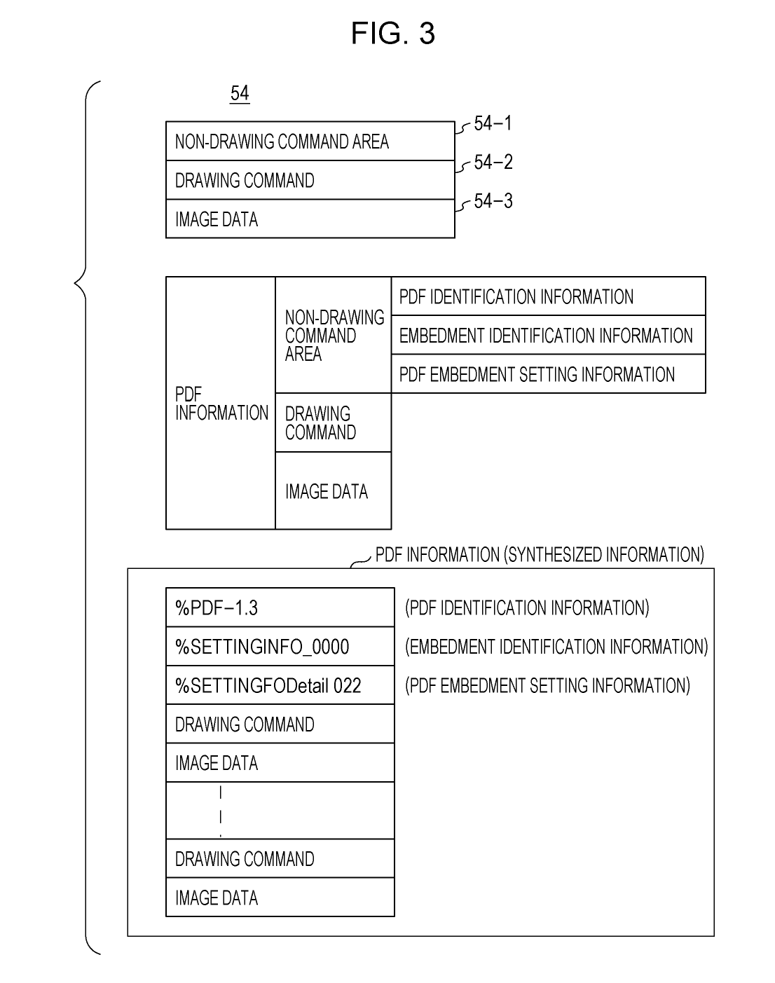

The image setting synthesis unit 19 is a part for generating file information (synthesized information) obtained by synthesizing image data which is inputted (input image data) and embedment setting information which is generated from acquired setting information. Hereinafter, file information obtained by synthesizing input image data and embedment setting information corresponding to setting information is also referred to as synthesized information. The embedment setting information is placed in an area not outputted in the synthesized information. File information (PDF information or PDF file) in a PDF format corresponding to the synthesized information includes image data, drawing commands corresponding to the image data, and a non-drawing command area. The non-drawing command area stores the PDF identification information, the PDF embedment setting information corresponding to the setting information, and input image data according to the PDF format in an area subsequent to the areas of the PDF identification information and the PDF embedment setting information. Accordingly, the synthesized information in a PDF format is generated. The synthesized information in a PDF format of the embodiment is shown in FIG. 3 to be described later. As image data, a two-dimensional code corresponding to the PDF embedment setting information may be generated.

According to the present disclosure, as described later, when the image input unit 13 inputs information written on another document as new image data based on setting contents of setting items which is reset in the image processing apparatus, the image setting synthesis unit 19 generates synthesized information obtained by synthesizing the inputted new image data and embedment setting information acquired from the synthesized information already stored in the storage unit 50.

The setting information extraction unit 20 is a part for reading out a predetermined synthesized information from the storage unit 50, acquiring the embedment setting information included in the synthesized information, and extracting the setting information which is originally inputted from the acquired the embedment setting information, when synthesized information is already stored in the storage unit 50. Further, as described later, the setting information extraction unit 20 analyzes the two-dimensional code acquired by the two-dimensional code acquisition unit 22, acquires the embedment setting information included in the two-dimensional code, and extracts the setting information which is originally inputted from the acquired the embedment setting information. The extracted setting information is stored in the storage unit 50 as extracted setting information 55. For example, when the embedment setting information includes information corresponding to four setting items of a resolution, a color, a compression, and a density, contents of the embedment setting information are analyzed, and setting information of these four setting items is extracted.

The setting restoration unit 21 is a part for resetting setting content of setting items in the image processing apparatus based on setting information extracted by the setting information extraction unit 20. That is, each setting item in the setting information (extracted setting information) extracted by the setting information extraction unit 20 is automatically reset to the actual setting items of the image processing apparatus MFP. For example, setting information 51 of the storage unit 50 is overwritten with a content of temporarily stored extracted setting information. An image scanning function is executed based on the setting items of the setting information after being overwritten.

In a case of using the setting information included in a PDF information (PDF file) already stored in the storage unit 50 to execute image scanning on another new document with contents of the same setting items, by restoring the setting information included in the PDF information and automatically setting the setting information in the actual setting items of the MFP, there is no need for a user to perform the setting input again of the same setting items and scanning of the other new document by the scanner can be easily performed.

The two-dimensional code acquisition unit 22 is a part for acquiring a two-dimensional code included in the image data inputted by the scanner.

For example, after the two-dimensional code is printed on a paper sheet by the output unit 16 and the information of the paper sheet on which the two-dimensional code is printed by the image input unit 13 is inputted as image data, the two-dimensional code included in the inputted image data is acquired.

When the two-dimensional code includes information corresponding to the embedment setting information, by scanning the two-dimensional code printed on the paper sheet by the scanner and analyzing the scanned two-dimensional code, the embedment setting information included in the two-dimensional code is taken out. The original setting information in which the setting input is performed is extracted from the embedment setting information which is taken out, and is temporarily stored in the storage unit 50 as extracted setting information.

The two-dimensional code generation unit 23 is a part for converting embedment setting information generated by an embedment information generation unit 18 into a two-dimensional code. The two-dimensional code is temporarily stored in the storage unit 50 and is printed on a paper medium or the like, for example.

The storage unit 50 is a part for storing information or a program in which the image processing apparatus of the present disclosure may need for executing each function, and a semiconductor storage element such as a ROM, a RAM, a flash memory, a storage device such as an HDD, an SSD, and other storage medium are used.

In the storage unit 50, for example, setting information 51, embedment setting information 52, input image data 53, synthesized information 54, extracted setting information 55, a two-dimensional code 56, PDF information (PDF file) 57, or the like are stored.

The setting information 51 is information of setting items preset by the user as described above.

The setting information 51 of the embodiment is shown in FIG. 2A. As setting items, items include four pieces of information of a resolution, a color mode, a compression ratio, and a density are shown.

The resolution is information indicating a scanning performance, a user selects and performs a setting input from a plurality of resolutions prepared in advance, for example, 150 dpi, 200 dpi, 300 dpi, 400 dpi, 600 dpi, or the like.

The color mode is information for designating a color to be scanned, a user selects and performs a setting input from a plurality of information prepared in advance, for example, automatic, color, grayscale, black and white, or the like. When the automatic is set, color information of a document is reviewed once, and it is automatically determined which one of color, grayscale, black and white is appropriate to scan the document.

The compression ratio is information for designating a ratio of compressing scanned raw image data, a user selects and performs a setting input from a plurality of information prepared in advance, for example, low compression ratio, medium compression ratio, high compression ratio, or the like. The ratio of compression may be inputted as a numerical value.

The density is information for designating a content of a document to be scanned, a user selects and performs a setting input from a plurality of information prepared in advance, for example, automatic, character, character/print photograph, character/photographic paper photograph, photographic paper photograph, map, or the like. When the automatic is set, the content of the document is reviewed once, and it is automatically determined which information among character, photograph, map, or the like, is written mainly on the document, and then the appropriate density for the document is set.

The setting information 51 in FIG. 2A shows setting values when a resolution is set “300 dpi”, a color mode is set to “automatic”, a compression ratio is set to “medium compression” and a density is set to “automatic”.

However, the setting items are not limited to these four pieces of information, and other information such as an OCR, a blank page skipping, a file division, or the like may also be set.

As described above, the embedment setting information 52 is information obtained by converting the acquired setting information 51 into information that is capable of embedding in predetermined image information. For example, the setting information 51 is displayed on the display unit 14 with character information that a user is able to read. The embedment setting information 52 is binary information obtained by converting the character information in a predetermined format.

The embedment setting information 52 of the embodiment is shown in FIG. 2B. FIG. 2B shows that the setting information including a resolution, a color mode, a compression ratio, and a density is converted into the embedment setting information 52.

In FIG. 2B, the embedment setting information 52 includes data of ten bits in total, a resolution and a density are defined as binary embedment data of three bits each, and a color mode and a compression ratio are defined as binary embedment data of two bits each. For example, for the resolution, five types of setting contents are distinguished with three bits of embedment data different from each other. Also, for the color mode, four types of setting contents are distinguished with two bits of embedment data different from each other, for the compression ratio, three types of setting contents are distinguished with two bits of embedment data different from each other, and for the density, seven types of setting contents are distinguished with three bits of embedment data different from each other.

When the resolution is set to “300 dpi”, the color mode is set to “automatic”, the compression ratio is set to “medium compression” and the density is set to “automatic” as shown in the setting information 51 in FIG. 2A, “010” is set as information corresponding to the resolution “300 dpi”, “00” is set as information corresponding to the color mode “automatic”, “01” is set as information corresponding to the compression ratio “medium compression ratio”, and “000” is set as information corresponding to the density “automatic” in the embedment setting information 52 shown in FIG. 2B. Further, these four-bit string data are arranged in a predetermined order to generate one-bit string data of ten bits in total. If the embedment setting information 52 of the bit string data is represented in hexadecimal number, it is represented as 0x022. In this manner, the embedment setting information 52 obtained by converting the setting information 51 into bit string data is stored in the storage unit 50.

In FIG. 2B, the embedment data of bit string is shown for the four setting items. However, if there is another setting item, similarly, the embedment data of bit strings corresponding to the other setting item is defined, then the embedment setting information 52 may include the embedment data which is set.

The input image data 53 is an image inputted by the image input unit 13. For example, the input image data 53 is data obtained by inputting information such as a character written on a surface of a scanned document by the scanner as an image. Also, for example, when the input image data 53 is saved as information in a PDF format, it is stored in the storage unit 50 as PDF format file data.

The synthesized information 54 is, as described above, file information obtained by synthesizing the input image data and the embedment setting information corresponding to the setting information. The synthesized information 54 is stored in the storage unit 50, it may also be temporarily stored by acquiring the synthesized information from another storage medium or another information processing apparatus by an instruction input by a user.

The synthesized information 54 of the embodiment is shown in FIG. 3. In FIG. 3, the synthesized information 54 includes image data 54-3, drawing commands 54-2 corresponding to the image data, and a non-drawing command area 54-1 at a head of a file, and the embedment setting information is placed in the non-drawing command area 54-1. The non-drawing command area 54-1 is an area in which information not outputted by the output unit 16 is paced.

When the synthesized information 54 is information in a PDF format (PDF information), PDF identification information, embedment identification information, and PDF embedment setting information are placed in the non-drawing command area 54-1.

In a case of PDF information, the PDF embedment setting information may be outputted so that a user reviews the PDF embedment setting information included in the non-drawing command area. In the PDF information, the drawing commands 54-2 and the image data 54-3 are placed after the non-drawing command area 54-1. There may be one set of information including the drawing commands 54-2 and the image data 54-3, and a plurality of the sets may be placed in the PDF information.

That is, as in a data structure of the PDF information of the embodiment shown in FIG. 3, PDF identification information, embedment identification information, and PDF embedment setting information are placed in the PDF information in the above order, and thereafter, a plurality of pieces of information including the drawing commands 54-2 and the image data 54-3 are placed in the PDF information. Here, “%PDF-1.3” is PDF identification information, “%SETTINGFO_0000” is embedment identification information, and “%SETTINGFODetail 022” is PDF embedment setting information. By reviewing the information in the non-drawing command area 54-1, it is determined that whether or not it is a file in a PDF format, whether or not the PDF embedment setting information is included, and a content of the setting information which is embedded (embedment setting information 52).

For example, it is determined that whether or not the input file information is information in a PDF format by whether or not the information at a head of the file is a string beginning with %PDF (0x25, 0x50, 0x44, 0x46). It is determined that whether or not the PDF embedment setting information is included by whether or not embedment identification information including a specific string exists in the non-drawing command area. For example, in the embodiment of FIG. 3, SETTINGINFO_0000 corresponds to the embedment identification information.

Further, the embedment setting information 52 can be obtained by referring to a value following a specific string indicating an existence of the embedment setting information in the PDF embedment setting information in the non-drawing command area. For example, in the embodiment of FIG. 3, SETTINGINFODetail is the specific string indicating the existence of the embedment setting information, and the subsequent 022 corresponds to the embedment setting information 52.

In this manner, by reviewing the PDF embedment setting information stored in the command area of the PDF information, for example, when reading out the PDF image data stored in the image area of the same PDF information, the contents of the setting items in which a user performed a setting input can be reproduced.

As described above, the extracted setting information 55 is setting information extracted from the embedment setting information included in the synthesized information by the setting information extraction unit 20. The content of the extracted setting information 55 includes a plurality of setting items, as with the setting information 51.

The two-dimensional code 56 is a code generated by the two-dimensional code generation unit 23 or acquired by the two-dimensional code acquisition unit 22, and any of various two-dimensional codes currently used may be used.

The PDF information (PDF file) 57 corresponds to the synthesized information 54 described above, and the PDF information 57 is file information in a PDF format as shown in FIG. 3. There is PDF information including PDF embedment setting information, and PDF information not including PDF embedment setting information. With the PDF information including the PDF embedment setting information, as described above, it is possible to reproduce the contents of the setting items in which a user performed a setting input during a scanning by using the PDF embedment setting information.

### Acquisition Process of Setting Information and Generation Process of Synthesized Information in Image Processing Apparatus

### Embodiment 1

In Embodiment 1, a process of extracting PDF embedment setting information from image information in a PDF format (PDF file) and taking out a setting information in which a setting input is performed, will be described. Processing of image information in a PDF format will be described but image information of another image format such as a TIFF format can also acquire the setting information in which a setting input is performed, by performing similar processing.

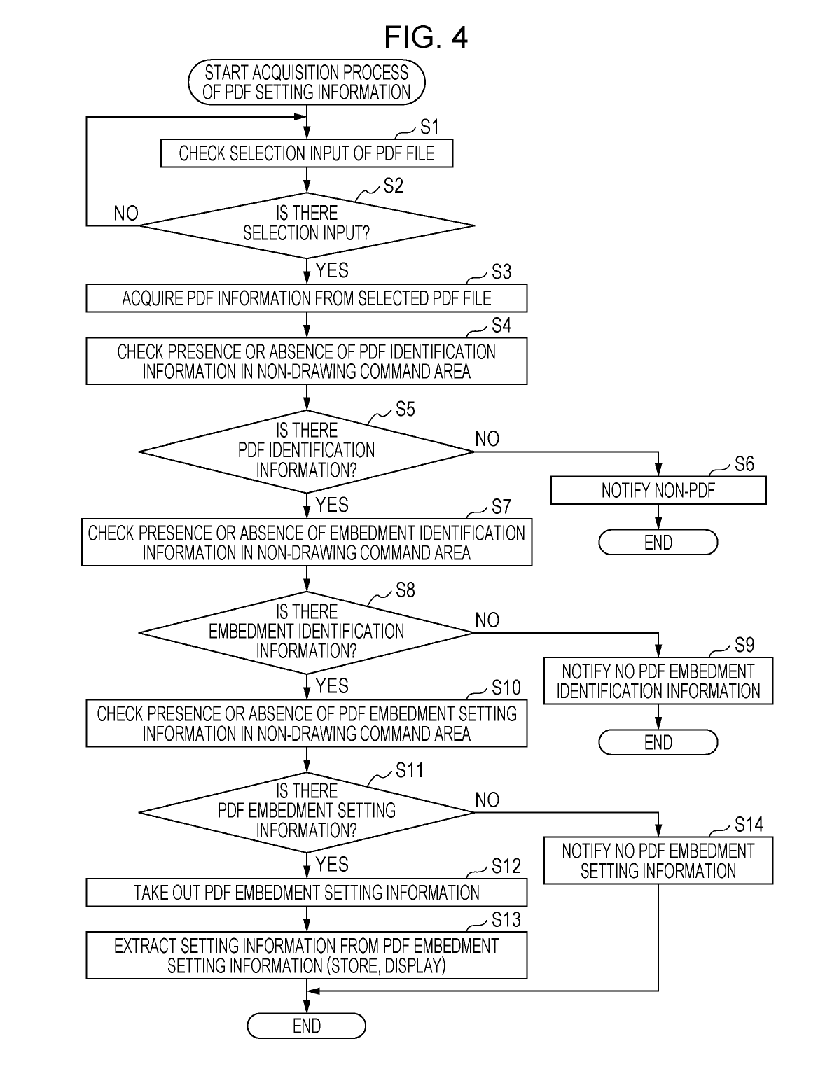

FIG. 4 is a flowchart of an acquisition process of PDF setting information on the image processing apparatus according to the embodiment of the present disclosure. It is assumed that image information (PDF file) in a PDF format in which the PDF embedment setting information as described above is embedded, is already stored in a storage unit 50. The PDF file in which the PDF embedment setting information is embedded may be received from another portable terminal or server and temporarily stored in the storage unit 50.

In step S1 of FIG. 4, the control unit 11 checks whether or not a selection input of a PDF file is performed by a user. In a case where a plurality of PDF files is stored in the storage unit 50, for example, a list display of a plurality of PDF file names is displayed on a display unit 14, and the user may perform an operation of selecting a desired PDF file name for which setting information is to be acquired by using an operation unit 12.

In step S2, if the user performs an operation input to select the desired PDF file name, the process proceeds to step S3, and if not, the process returns to step S1.

In step S3, PDF information as a content of the selected PDF file name is acquired from the storage unit 50. As shown in FIG. 3, the PDF information is information of a structure having image data, drawing commands corresponding to the image data, and a non-drawing command area.

In step S4, the setting information extraction unit 20 reviews the non-drawing command area of the acquired PDF information and checks a presence or absence of PDF identification information.

In step S5, when the PDF identification information is in the non-drawing command area, the process proceeds to step S7, and if not, the process returns to step S6.

In step S6, since the file selected by the user is not a file in a PDF format, using the display unit 14 or the like, the user is notified that the selected file is not a PDF and the process is terminated. Alternatively, after notifying, returning to step S1, the user may be asked to perform a selection input of the file once again.

In step S7, the setting information extraction unit 20 reviews the non-drawing command area of the acquired PDF information and checks a presence or absence of embedment identification information.

In step S8, when the embedment identification information is in the non-drawing command area, the process proceeds to step S10, and if not, the process returns to step S9.

In step S9, since the PDF embedment identification information is not included in the user selected PDF file, using the display unit 14 or the like, the user is notified that the setting information is not embedded in the selected file, and the process is terminated. Alternatively, after notifying, returning to step S1, the user may be asked to perform the selection input of the file once again.

In step S10, the setting information extraction unit 20 reviews the non-drawing command area of the acquired PDF information and checks a presence or absence of PDF embedment identification information.

In step S11, when the PDF embedment identification information is in the non-drawing command area, the process proceeds to step S12, and if not, the process returns to step S14.

In step S14, since the PDF embedment identification information is not included in the user selected PDF file, using the display unit 14 or the like, the user is notified that the setting information is not embedded in the selected file, and the process is terminated. Alternatively, after notifying, returning to step S1, the user may be asked to perform a selection input of the file once again.

In step S12, the setting information extraction unit 20 takes out the PDF embedment setting information in the non-drawing command area.

In step S13, the setting information extraction unit 20 extracts the setting information in which the user performed the setting input from the PDF embedment setting information which is taken out, and the process is terminated. The extracted setting information is stored in the storage unit 50 as extracted setting information 55. Alternatively, in order for the user to review the content of the extracted setting information, the extracted setting information 55 may be displayed on the display unit 14.

By the above processing, it is possible to acquire the setting information included when the PDF file is generated from the existing PDF file stored in the storage unit 50. The acquired setting information can be reused when generating another PDF file or scanning another document.

In this way, since setting information to be reused is taken out from image information such as a PDF file including existing setting information already stored in the storage unit or the like, a user can reproduce the setting information with an easy input operation when generating another PDF file or the like, a re-operation of a same setting input may not need for each setting item, a management may not need for a paper medium on which a two-dimensional code corresponding to the setting information is printed, and it is possible to reduce a burden on the management and the operation of the user.

### Embodiment 2

In Embodiment 2, a process of scanning a two-dimensional code including information that coded setting information inputted by a user, taking out PDF embedment setting information from the two-dimensional code, and extracting the setting information in which a setting input is performed, will be described. Processing of image information in a PDF format will be described but image information of another file format such as a TIFF format can also acquire the setting information in which a setting input is performed, by performing similar processing.

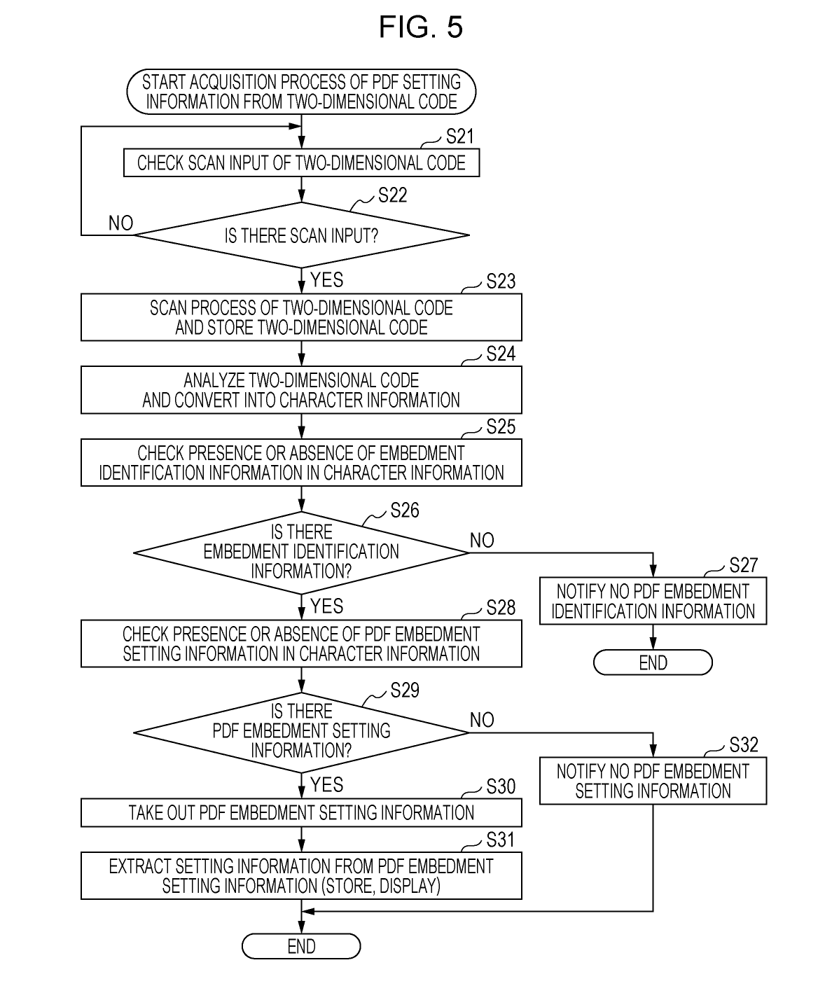

FIG. 5 is a flowchart of an acquisition process of PDF setting information from a two-dimensional code according to the embodiment of the present disclosure. As a premise, a two-dimensional code including information in which setting information is coded, is created in advance and a user already has a paper sheet on which the two-dimensional code is printed. Also, the two-dimensional code includes information in which embedment identification information and PDF embedment setting information are coded, as shown in FIG. 3.

The user knows that the printed two-dimensional code includes desired setting information, and in order to acquire the setting information, the user places the paper sheet on which the two-dimensional code is printed on a document table of the image processing apparatus, and performs an operation input signifying a start of scanning the two-dimensional code.

In step S21 of FIG. 5, the control unit 11 checks whether or not a scan input of a two-dimensional code is performed by a user.

In step S22, when the user performs an operation input signifying a start of scanning of the two-dimensional code, the process proceeds to step S23, and if not, the process returns to step S21.

In step S23, the image input unit 13 scans a paper sheet on which the two-dimensional code is printed, scans the two-dimensional code, and temporarily stores the scanned two-dimensional code 56 in the storage unit 50.

In step S24, the two-dimensional code acquisition unit 22 analyzes the two-dimensional code and converts the two-dimensional code into character information.

In step S25, the two-dimensional code acquisition unit 22 checks whether or not embedment identification information is included in the character information.

In step S26, when the embedment identification information is in the character information, the process proceeds to step S28, and if not, the process returns to step S27.

In step S27, since the PDF embedment identification information is not included in the scanned two-dimensional code, using the display unit 14 or the like, the user is notified that the setting information is not embedded in the two-dimensional code, and the process is terminated. Alternatively, after notifying, returning to step S21, the user may be asked to perform a scan input of another two-dimensional code once again.

In step S28, the two-dimensional code acquisition unit 22 reviews the character information and checks a presence or absence of PDF embedment setting information.

In step S29, when the PDF embedment setting information is in the character information, the process proceeds to step S30, and if not, the process returns to step S32.

In step S32, since the PDF embedment setting information is not included in the character information, using the display unit 14 or the like, the user is notified that the setting information is not embedded in the scanned two-dimensional code, and the process is terminated. Alternatively, after notifying, returning to step S21, the user may be asked to perform the scan input of another two-dimensional code once again.

In step S30, the two-dimensional code acquisition unit 22 takes out the PDF embedment setting information included in the character information.

In step S31, the setting information extraction unit 22 extracts the setting information in which the user performed the setting input from the PDF embedment setting information which is taken out, and the process is terminated. The extracted setting information is stored in the storage unit 50 as extracted setting information 55. Alternatively, in order for the user to review the content of the extracted setting information, the extracted setting information 55 may be displayed on the display unit 14.

By the above processing, it is possible to acquire setting information included in a two-dimensional code from a two-dimensional code printed on a paper sheet. The acquired setting information can be reused when generating another PDF file or scanning another document.

### Embodiment 3

In Embodiment 3, a process of generating PDF information (PDF file) in which a user converts a predetermined document into a PDF will be described. In order to convert the predetermined document into a PDF, a document is scanned by the scanner. Before executing a scanning of the document, the user performs a setting input of setting items such as a resolution, which is scanning condition of the document, using the operation unit 12. The PDF information to be generated is synthesized information including PDF embedment setting information corresponding to the setting information in which the user performed the setting input and input image data of the scanned document. Processing of generating of synthesized information in a PDF format will be described, but synthesized information of another file format such as a TIFF format can also be generated, by performing similar processing.

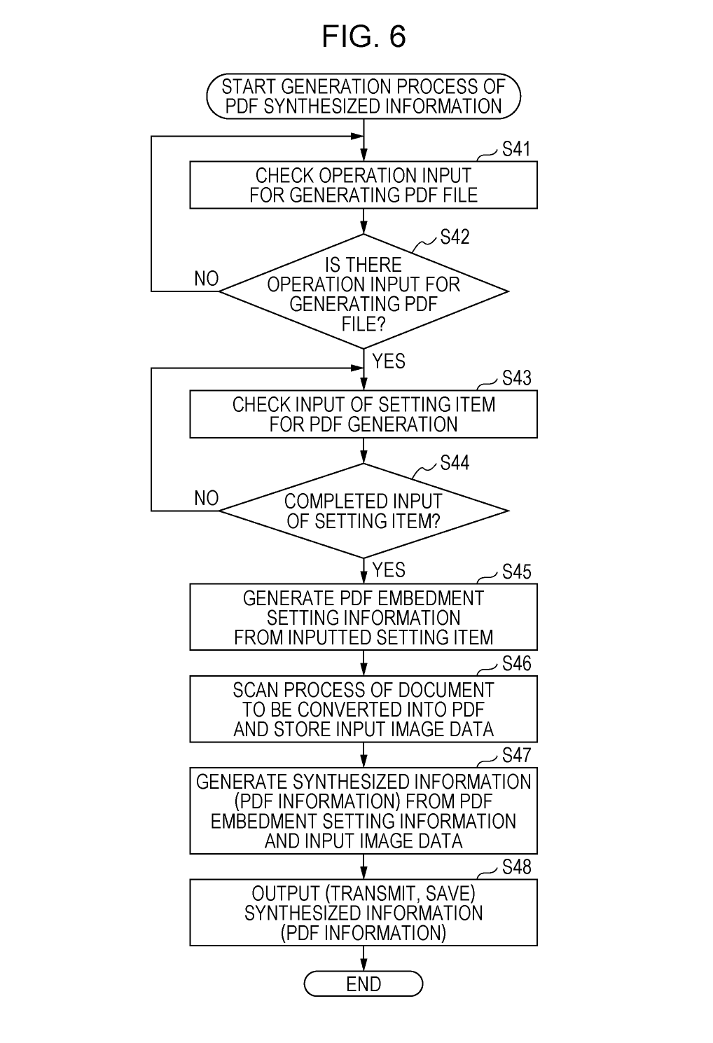

FIG. 6 is a flowchart of a generation process of PDF synthesized information on the image processing apparatus according to the embodiment of the present disclosure.

In step S41 of FIG. 6, the control unit 11 checks whether or not an operation input for generating a PDF file is performed. For example, the control unit 11 displays a function selection menu including a plurality of functions, and checks whether or not the user performed a function selection which means to generate a PDF file.

In step S42, if the user performed an input which means to generate a PDF file, the process proceeds to step S43, and if not, the process returns to step S41.

In step S43, the setting information acquisition unit 17 checks that the setting items for generating the PDF file are inputted, and stores the setting content in the setting information 51 when the setting items are inputted. For example, when the user performed the setting input for a content of a resolution among the setting items, the content of the resolution is stored in the setting information 51.

In step S44, when the input of the setting items are completed, the process proceeds to step S45, and if not, the process returns to step S43.

In step S45, the embedment information generation unit 18 generates PDF embedment setting information 52 from the setting information 51 that stores the contents of the inputted setting items. For example, as described above, the PDF embedment setting information 52 as shown in FIG. 2B is generated for the setting information 51 shown in FIG. 2A.

In step S46, the image input unit 13 performs a scanning process of the document to be converted into a PDF. When the user performs an operation input signifying the start of the scanning of the document, the scanning process of the document placed on the document table is executed, and input image data 53 in which the description information of the document is binarized is stored in the storage unit 50.

In step S47, the image setting synthesis unit 19 uses the PDF embedment setting information 52 and the input image data 53 to generate synthesized information 54 including PDF embedment setting information 52 and the input image data 53. PDF information corresponding to the synthesized information 54 is generated. As shown in FIG. 3, the PDF information includes image data, drawing commands corresponding to the image data, and information of a non-drawing command area at a head of a file.

In step S48, the output unit 16 outputs the generated synthesized information 54, and the process is terminated. For example, the generated synthesized information 54 is stored in the storage unit 50, after that the synthesized information 54 may be saved in a storage medium such as a USB memory, transmitted to another information processing apparatus or server by a communication unit 15, and printed the generated PDF information on the paper sheet.

Note that, an output of the synthesized information 54 is not limited to a saving, a transmitting, and a printing. When printing on a paper sheet, the PDF embedment setting information 52 may be removed, and only the PDF image data may be printed. In order to review the setting information, the PDF embedment setting information 52 may be printed.

By the above processing, synthesized information including the image data of the document to be converted into a PDF and the setting information in which the user performed the setting input, is generated.

### Embodiment 4

In Embodiment 4, a process of generating synthesized information in which a user converts another document into a PDF by using setting information included in already generated PDF information (PDF file) will be described. In other words, a process of reusing the setting information in which the user performed a setting input beforehand in a case of converting the other document into a PDF will be described. Image information (PDF file) in a PDF format in which the PDF embedment setting information as described above is embedded, may be already stored in a storage unit 50.

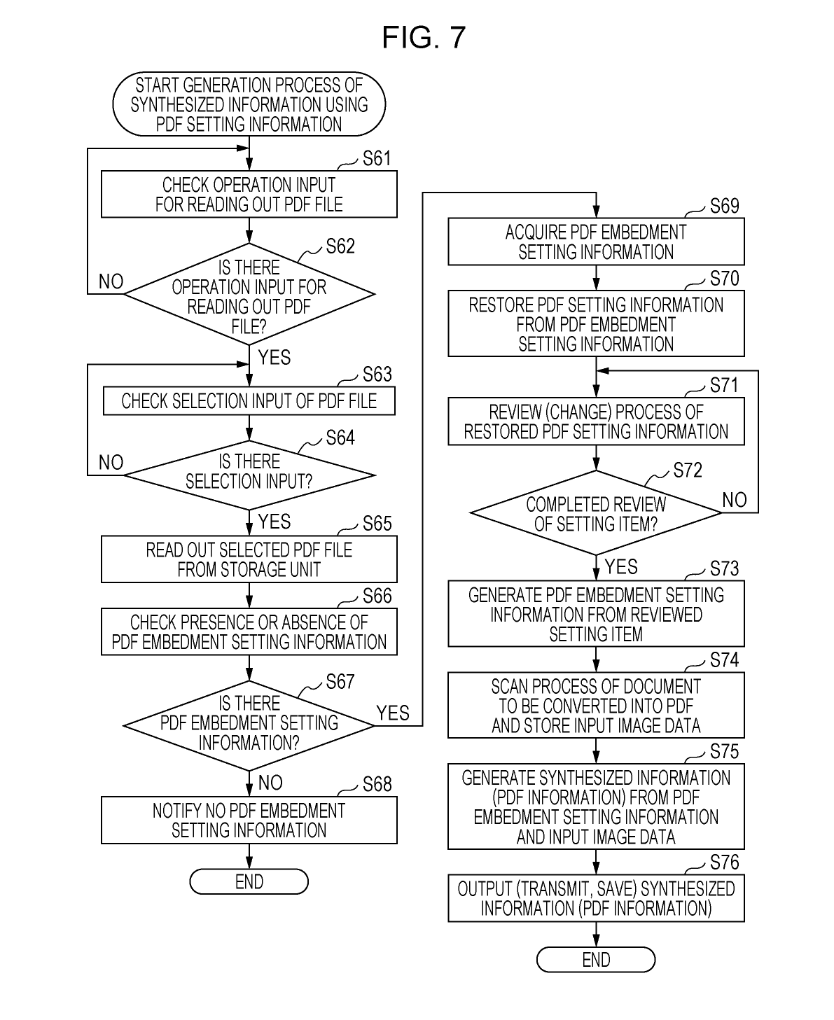

FIG. 7 is a flowchart of a generation process of synthesized information using PDF embedment setting information on the image processing apparatus according to the embodiment of the present disclosure.

In step S61 of FIG. 7, the control unit 11 checks whether or not an operation input signifying that a PDF file is to be read out is performed by a user.

In step S62, if the user performed an input which means to read out a PDF file, the process proceeds to step S63, and if not, the process returns to step S61.

In step S63, the control unit 11 checks whether or not a selection input of a PDF file is performed by a user. In a case where a plurality of PDF files is stored in the storage unit 50, in the same manner as in step S1, a list display of a plurality of PDF file names is displayed on the display unit 14, and the user may perform an operation of selecting a desired PDF file name for which the setting information is to be acquired by using the operation unit 12.

In step S64, if the user performs an operation input to select a desired PDF file name, the process proceeds to step S65, and if not, the process returns to step S63.

In step S65, PDF information as a content of the selected PDF file name is read out from the storage unit 50.

In step S66, it is checked whether or not PDF embedment setting information is included in the PDF information which is read out. As shown in FIG. 3, the PDF information is information of a structure having image data, drawing commands corresponding to the image data, and information of a non-drawing command area at a head of a file. Therefore, it is checked whether or not the non-drawing command area includes the PDF embedment setting information.

In step S67, when the PDF embedment setting information is included, the process proceeds to step S69, and if not, the process returns to step S68.

In step S68, since the PDF embedment identification information is not included in the user selected PDF file, using the display unit 14 or the like, the user is notified that the setting information is not embedded in the selected file, and the process is terminated. Alternatively, after notifying, returning to step S63, the user may be asked to perform a selection input of the file once again.

In step S69, the PDF embedment setting information is acquired from the user selected PDF file.

In step S70, the setting restoration unit 21 restores the setting information (PDF setting information) in which the user performed the setting input at a time of creation of the PDF file from the acquired PDF embedment setting information. A setting content of the current setting items of the MFP is reset based on the acquired PDF embedment setting information. That is, the contents of the setting items based on the acquired PDF embedment setting information are stored in the setting information 51 of the storage unit 50.

In step S71, a review process of restored PDF setting information is performed. For example, the contents of the setting items of the restored PDF setting information is displayed on the display unit 14, and the user reviews the contents thereof. If the content of the displayed setting item is different from a content intended by the user, the user may change the content of the setting items by using the operation unit 12. If there is no problem with the contents of the displayed setting items, the user performs an operation input signifying terminating the review of the setting items.

In step S72, if the user performed an operation input which means to terminate the review of the setting items, the process proceeds to step S73, and if not, the process returns to step S71. Note that, when not reviewing the setting items, the processing of step S71 and step S72 may be skipped.

In step S73, the embedment information generation unit 18 generates PDF embedment setting information using the contents of the reviewed setting items. If there is no change in the contents of the setting items at the time of review, since the PDF embedment setting information is the same information acquired at step S69, there is no need to generate PDF embedment setting information again. If the content of the setting item is changed at the time of review, PDF embedment setting information is generated using the content of the changed setting item.

In step S74, in the same manner as in step S46, the image input unit 13 performs a scanning process of the document to be converted into a PDF. When the user performs an operation input signifying the start of the scanning of the document, the scanning process of the document placed on the document table is executed, and input image data 53 in which the description information of the document is binarized is stored in the storage unit 50.

In step S75, in the same manner as in step S47, the image setting synthesis unit 19 uses the PDF embedment setting information 52 and the input image data 53 to generate synthesized information 54 including PDF embedment setting information 52 and the input image data 53. PDF information corresponding to the synthesized information 54 is generated.

In step S76, similar to step S48, generated synthesized information 54 is outputted, and the process is terminated. For example, the generated synthesized information 54 is stored in the storage unit 50, thereafter, the synthesized information 54 may be saved in a storage medium such as a USB memory, transmitted to another information processing apparatus or server.

In this way, since setting information to be reused is taken out from image information such as a PDF file including existing setting information already stored in the storage unit 50, a user can reproduce the setting information with an easy input operation when generating another PDF file or the like, a re-operation of a same setting input may not need for each setting item, a management may not need for a paper medium on which a two-dimensional code corresponding to the setting information is printed, and it is possible to reduce a burden on the management and the operation of the user.

When there is a setting item to be changed when reviewing the restored setting information, the user may perform an operation input to change only the setting item to be changed with reference to the displayed setting information, therefore, it may not need to reset all the setting items again, accordingly, an operation burden on the user can be reduced.

### Embodiment 5

In Embodiment 5, a process of generating a two-dimensional code, and generating synthesized information further includes the two-dimensional code, by using setting information included already generated PDF information (PDF file) will be described.

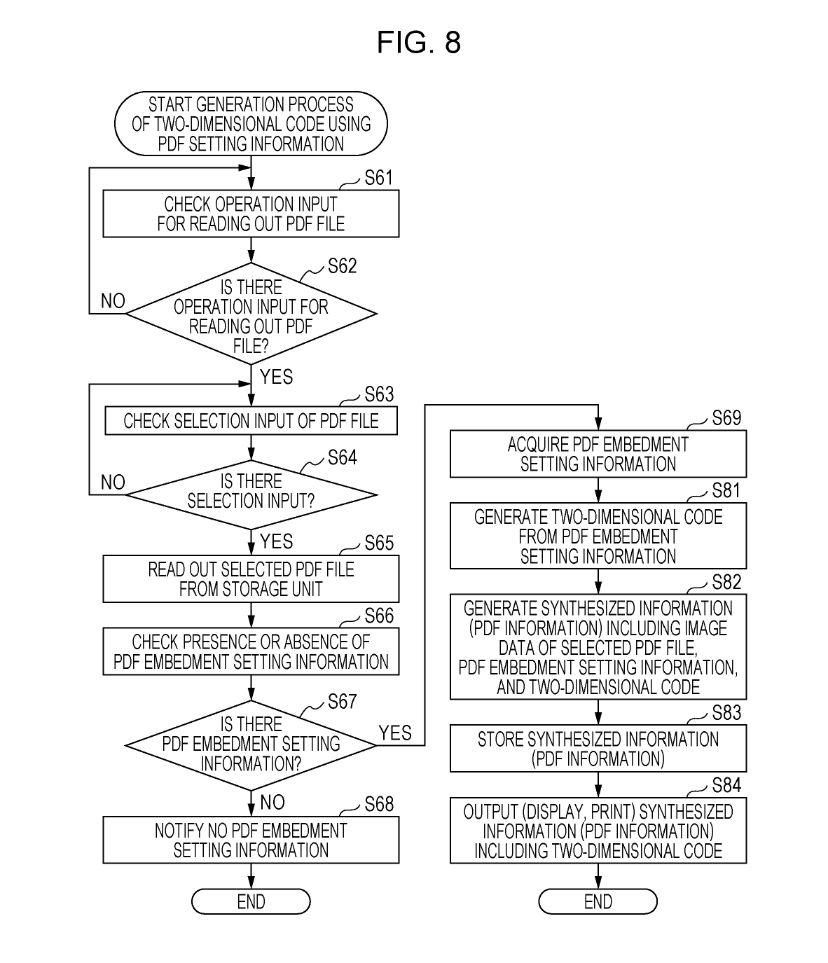

FIG. 8 is a flowchart of a generation process of two-dimensional code using the PDF embedment setting information on the image processing apparatus according to the embodiment of the present disclosure. In FIG. 8, the same reference numbers are assigned to the steps that perform the same processing as the step shown in FIG. 7.

First of all, in order to generate a two-dimensional code corresponding to setting information in which a user performed a setting input beforehand, an operation input signifying generation of the two-dimensional code may be performed. Next, in steps S61 to S69 of FIG. 8, the same processing as the processing shown in FIG. 7 is performed.

That is, in step S61, it is checked whether or not an operation input for reading out a PDF file is performed by the user, if an operation input signifying to read out the PDF file is performed, the process proceeds to step S63, and it is checked whether or not there is a selection input of the PDF file by the user.

In step S64, when the user performs an operation input to select a desired PDF file name, in step S65, the PDF information which is the content of the selected PDF file name is read out from the storage unit 50, and in step S 66 it is checked whether or not the PDF embedment setting information is included in the PDF information.

In step S67, the process proceeds to step S69 when the PDF embedment setting information is included, the process proceeds to step S68 when the PDF embedment setting information is not included, using the display unit 14 or the like, the user is notified that the setting information is not embedded in the selected file, and the process is terminated.

In step S69, the PDF embedment setting information 52 is acquired from the user selected PDF file.

In step S81, the two-dimensional code generation unit 23 generates a two-dimensional code 56 from the acquired PDF embedment setting information 52. The two-dimensional code generation processing may be performed by using existing two-dimensional code generation technology.

In step S82, the image setting synthesis unit 19 uses the selected PDF embedment setting information 52 and the generated two-dimensional code 56, and generates synthesized information 54 including PDF embedment setting information 52 and the two-dimensional code 56. PDF information corresponding to the synthesized information 54 is generated.

In step S83, the generated synthesized information (PDF information) 54 is stored in the storage unit 50.

In step S84, the synthesized information 54 including two-dimensional code is outputted, and the process is terminated. For example, the generated synthesized information 54 is saved in a storage medium such as a USB memory, transmitted to another information processing apparatus or server, and the generated PDF information is printed on the paper sheet. When printing the generated PDF information on a paper sheet, the PDF embedment setting information 52 may be removed, and only the two-dimensional code of the PDF file may be printed. In order to review the setting information, the PDF embedment setting information 52 may be included and printed.

By the above processing, two-dimensional code is generated by acquiring the setting information included in a PDF file which is a file of a document already stored in PDF format, and further, synthesized information including the two-dimensional code of the PDF file and the setting information in which the user performed a setting input is generated.

### Embodiment 6

In Embodiment 6, a process of acquiring PDF embedment setting information using a two-dimensional code already printed on a paper sheet, and generating synthesized information (PDF information) of another document using the PDF embedment setting information, will be described.

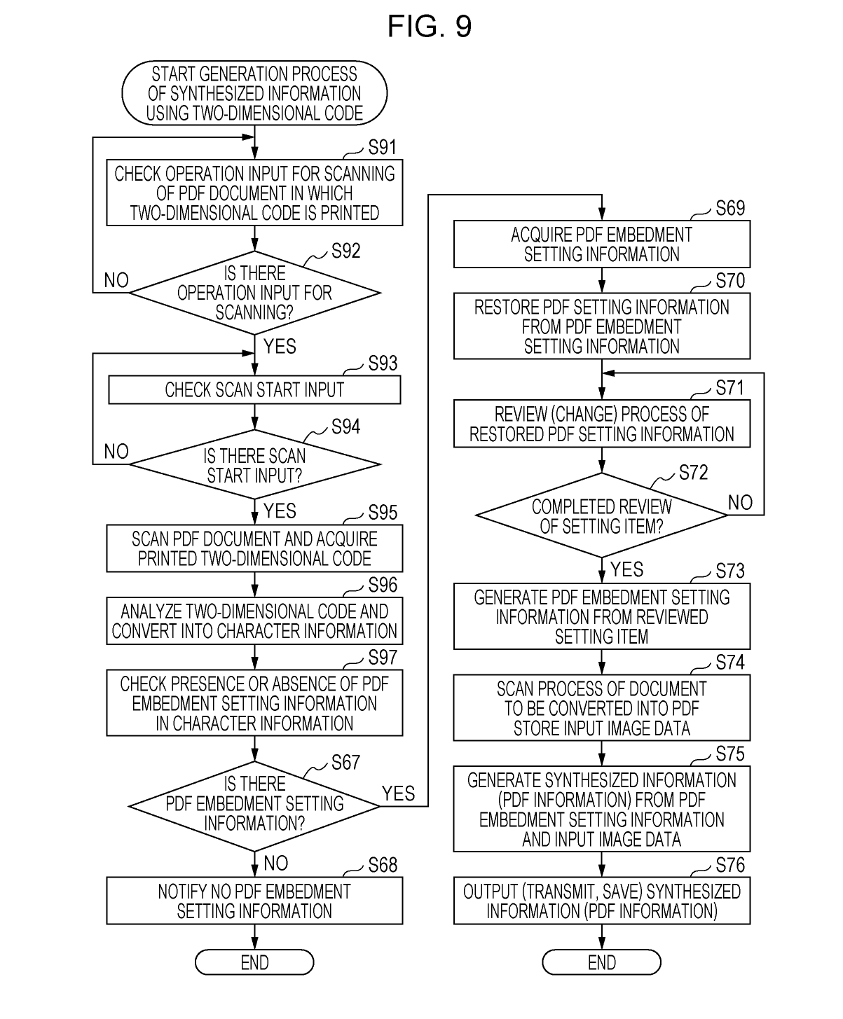

A user prepares a PDF document on which a two-dimensional code corresponding to setting information in which a user performed a setting input beforehand is printed. The PDF document on which the two-dimensional code is printed may not need to be saved on a paper medium in a long-term, the user may print the PDF document on which the two-dimensional code is written on a paper sheet and prepare the PDF document by executing a process shown in FIG. 8 immediately before executing a process shown in FIG. 9 described below. The PDF document is used to restore the setting information in which the user performed the setting input beforehand from the two-dimensional code.

In addition, another document to be converted into a PDF is prepared in advance by using the setting information that can be restored from the two-dimensional code.

FIG. 9 is a flowchart of a generation process of PDF synthesized information on the image processing apparatus according to the embodiment of the present disclosure. In FIG. 9, the same reference numbers are assigned to the steps that perform the same processing as the step shown in FIG. 7.

In step S91 of FIG. 9, the control unit 11 checks whether or not an operation to scan a PDF document on which a two-dimensional code is printed by the user is inputted.

In step S92, when the operation to scan the PDF document is inputted, the process proceeds to step S93, and if not, the process returns to step S91.

The user inputs the operation to scan the PDF document and the PDF document on which the two-dimensional code is printed is placed on the document table.

In step S93, the control unit 11 checks whether or not an input signifying that a start of scanning is performed by the user.

In step S94, if the user performed the input signifying that a start of scanning, the process proceeds to step S95, and if not, the process returns to step S93.

In step S95, the image input unit 13 scans the PDF document, and the two-dimensional code acquisition unit 22 acquires the two-dimensional code printed on the PDF document.

In step S96, a two-dimensional code acquisition unit 22 analyzes the acquired two-dimensional code and converts the two-dimensional code into character information.

In step S97, the two-dimensional code acquisition unit 22 reviews the character information and checks a presence or absence of PDF embedment setting information.

Next, a process similar to the process of steps S67 to S76 shown in FIG. 7, is performed. In step S67, when the PDF embedment setting information is in the character information, the process proceeds to step S69, and if not, the process returns to step S68.

In step S68, since the PDF embedment setting information is not included in the character information, using the display unit 14 or the like, the user is notified that the setting information is not embedded in the scanned two-dimensional code, and the process is terminated.

In step S69, the PDF embedment setting information is acquired from the user selected PDF file, and in step S70, the setting restoration unit 21 restores the setting information (PDF setting information) in which the user performed a setting input at a time of creation of the PDF file from the acquired PDF embedment setting information. A setting content of the current setting item of the MFP is reset based on the acquired PDF embedment setting information.

In step S71, if there is no problem in the restored PDF setting information after a review process of the restored PDF setting information is executed and reviewed by the user, and if the user performed an operation input which means to terminate the review of the setting item, the process proceeds to step S73, and if not, the process returns to step S71. For example, the contents of the setting items of the restored PDF setting information is displayed on the display unit 14, and the user reviews the contents thereof. If the content of the displayed setting item is different from a content intended by the user, the user may change the content of the setting item by using the operation unit 12.

In step S73, the embedment information generation unit 18 generates PDF embedment setting information using the contents of the reviewed setting items. If there is no change in the contents of the setting items at the time of review, since the PDF embedment setting information is the same information acquired at step S69, there is no need to generate PDF embedment setting information again. If the content of the setting item is changed at the time of review, PDF embedment setting information is generated using the content of the changed setting item.

In step S74, the image input unit 13 performs a scanning process of the document to be converted into a PDF. When the user performs an operation input signifying the start of the scanning of the document, the scanning process of the document placed on the document table is executed, and input image data 53 in which the description information of the document is binarized is stored in the storage unit 50.

In step S75, the synthesized information 54 including the PDF embedment setting information 52 and the input image data 53 is generated embedment setting information using the PDF embedment setting information 52 and the input image data 53. In step S76, the generated synthesized information 54 is outputted, and the process is terminated. For example, the generated synthesized information 54 is stored in the storage unit 50, thereafter, the synthesized information 54 may be saved in a storage medium such as a USB memory, transmitted to another information processing apparatus or server.

In this way, since setting information to be reused is taken out from image information such as a PDF file including existing setting information already stored in the storage unit or the like, a user can reproduce the setting information with an easy input operation when generating another PDF file or the like, a re-operation of a same setting input may not need for each setting item, a long-term saving may not need for a paper medium on which a two-dimensional code corresponding to the setting information is printed, and it is possible to reduce a burden on the management and the operation of the user.

When there is a setting item to be changed when reviewing the restored setting information, the user may perform an operation input to change only the setting item to be changed with reference to the displayed setting information, therefore, it may not need to reset all the setting items again, accordingly, an operation burden on the user can be reduced.

The present disclosure contains subject matter related to that disclosed in Japanese Priority Patent Application JP2017-215396 filed in the Japan Patent Office on Nov. 8, 2017, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing apparatus comprising:
a setting information acquisition unit acquiring setting information corresponding to an inputted predetermined setting item;
an embedment information generation unit converting the acquired setting information into embedment setting information having a predetermined data structure;
an image input unit inputting information written on a document as image data based on the setting information;
an image setting synthesis unit generating synthesized information obtained by synthesizing the inputted image data and the embedment setting information; and
an output unit outputting the synthesized information,
wherein the embedment setting information is placed in an area not outputted in the synthesized information.

2. The image processing apparatus according to claim 1,
wherein the output unit outputs the synthesized information by processing at least one of display of the synthesized information and transmission of the synthesized information to another information processing apparatus.

3. The image processing apparatus according to claim 1, further comprising
a display unit,
wherein, the display unit displays the embedment setting information in a readable state when the embedment setting information is placed in the area not outputted in the synthesized information.

4. The image processing apparatus according to claim 1,
wherein, in a case where the synthesized information is information in a PDF format, the synthesized information includes image data, a drawing command corresponding to the image data, and a non-drawing command area at a head of a file, and
wherein the embedment setting information is placed in the non-drawing command area.

5. The image processing apparatus according to claim 1, further comprising:
a storage unit storing the synthesized information;
a setting information extraction unit reading out predetermined synthesized information from the storage unit, acquiring the embedment setting information included in the synthesized information, and extracting the inputted setting information from the acquired embedment setting information; and
a setting restoration unit resetting a setting content of the setting item in the image processing apparatus based on the extracted setting information.

6. The image processing apparatus according to claim 5,
wherein the image input unit inputs information written on another document as new image data based on the setting content of the setting item reset in the image processing apparatus, and
wherein the image setting synthesis unit generates the synthesized information obtained by synthesizing the inputted new image data and the acquired embedment setting information.

7. The image processing apparatus according to claim 1,
wherein the image input unit is a scanner scanning the document in which information is written.

8. The image processing apparatus according to claim 1, further comprising
a two-dimensional code generation unit converting the embedment setting information into a two-dimensional code.

9. The image processing apparatus according to claim 8, further comprising:
a two-dimensional code acquisition unit acquiring, after the two-dimensional code is printed on a paper sheet by the output unit, and information on the paper sheet on which the two-dimensional code is printed is inputted by the image input unit as image data, the two-dimensional code included in the inputted image data;
a setting information extraction unit analyzing the acquired two-dimensional code, acquiring the embedment setting information included in the two-dimensional code, and extracting the inputted setting information from the acquired embedment setting information; and
a setting restoration unit resetting a setting content of the setting item in the image processing apparatus based on the extracted setting information.

10. An image processing method of an image processing apparatus, comprising:
acquiring setting information corresponding to an inputted predetermined setting item;
converting the acquired setting information into embedment setting information having a predetermined data structure;
inputting information written on a document as image data based on the setting information;
generating synthesized information obtained by synthesizing the inputted image data and the embedment setting information; and
outputting the synthesized information,
wherein the embedment setting information is placed in an area not outputted in the synthesized information.
